(19) United States
(12) Patent Application Publication
(10) Pub. No.: US 2007/0240178 A1
(43) Pub. Date: Oct. 11, 2007

(54) Apparatus and method for storing digital data

(76) Inventor: Richard G. Kleker, Pleasant Hill, CA (US)

Correspondence Address: RONALD ROHDE, 2625 MIDDLEFIELD ROAD #119, PALO ALTO, CA, 94306, US

(21) Appl. No.: 11/399,796

(22) Filed: Apr. 7, 2006

(51) Int. Cl. G11B 7/24; G11B 23/03

(52) U.S. Cl. 720/718

(57) ABSTRACT

A data storage apparatus is described. The apparatus includes a host CD or DVD type disk having an aperture or cavity. A data insert fits into the aperture or cavity. The data insert and host disk contain digital data. The data insert is secured in the host disk cavity for reading by a CD or DVD type disk reader. The data insert can hold large amounts of digital data in a small package for inclusion with consumer products such as prescription medications, cosmetics, consumer parts, kits, or toys. The data may include product information regarding safety, images, sound, video, assembly instructions, warranties, demonstration programs, etc. The host disk may contain encrypted data and the data insert may contain an encryption key. The data insert may contain enciphered data and the host disk an encryption key. Such a system could enhance disk security in banking, medicine, national security institutions, accounting etc.

### CROSS REFERENCE TO RELATED APPLICATIONS

The copending Provisional Patent Application Ser. No. ______ filed on Apr. 7, 2002 entitled “APPARATUS AND METHOD FOR STORING DIGITAL DATA,” commonly owned, is hereby incorporated by reference in its entirety.

### BACKGROUND OF THE INVENTION

1. Field of the Invention

Embodiments of the present invention generally relate to an apparatus and method for storing digital data in optical readable form.

2. Description of the Related Art

The optical data disk, often referred to as a data disk, compact disk or more simply “CD”, has proven to be a very successful method for storing large amounts of information optically encoded in digital format, typically in plastic media. Such plastic media can easily be reproduced inexpensively and in large quantities by standard printing and stamping techniques well know to practitioners in the industry. Moreover, techniques have been developed for recording digital data directly from computer onto specially prepared media. Data, music, software, and video information are all commonly recorded on this medium. The digital video disk or “DVD” was developed in an effort to record increased amounts of digital data on media in order to accommodate the increased data requirements to record enough data to place an entire movie in video form on a disk. DVD's are able to hold many times as much data as CD's by various techniques including smaller bit size, a tighter track pattern, storing the data in multiple layers and using both surfaces of the disk.

The diameter of the standard CD and DVD is about 120 mm. Reduced size CD's and DVD's are also in use that have a standard diameter of about 80 mm. The standard CD and DVD, reduced size CD and DVD, all include a central aperture having a diameter of about 15.0 mm for engaging a spindle and a standard information area starting at about diameter 44 mm. Unfortunately, this standard information area starting at diameter 44 mm places a specific limit on the reduction in the diameter of the CD and DVD. This diameter limit in turn limits packaging and distribution modes for CD's and DVD's. For example, CD's typically cannot be placed inside small packages such as prescription medications, cosmetics, small consumer parts, or small toys.

There have been many efforts to reduce the size of media for holding digital data. For example, one type of storage media involves reducing the size of a magnetic digital disk for a computer by cutting it in half. One half of a disk could be placed in a specially designed diskette and read by a computer diskette disk drive. The half disk would act as a business card since it was of similar size. The half disk could contain much more information then a typical business card.

Attempts have also been made to reduce the size of standard optical digital disks. In one example, the optical disk is reduced in size and shape to about that of a typical event ticket. Two opposing sides, however, have the standard 80 mm diameter so that the ticket fits properly in the tray of a typical optical disk drive. This approach has also been proposed for credit cards. In another example, the optical disk is reduced in size and shape to about that of a typical sport trading card. Since the trading cards are somewhat larger then the standard 80 mm diameter, ridges are placed on the back of the trading card that fit the 80 mm format and allow the playing card to fit properly in the tray of a typical optical disk drive. Another design uses a jig that fits the 120 mm tray format and has a holder for the sport trading card. Unfortunately, such digital media, though reduced in size, still require that at least one dimension is 80 mm or more in length.

Yet another example includes a disk carousel for holding small sized solid state smart cards. The carousel is designed to fit into a standard digital disk drive, to which has been added a special carousel positioning mechanism and a contact reader head that clamps onto the solid state smart cards one at a time. Unfortunately, the disk size carousel and an optical digital disk cannot be used at the same time. Moreover, the smart cards have no optical information properties and are incompatible with a typical optical disk drive.

What is needed is a method and apparatus for reading digital data encoded optically on small pieces of optical digital media using optical disk drives, such as typical CD and DVD drives found in computers.

### SUMMARY OF THE INVENTION

An aspect of the present invention is an apparatus that includes a data storage insert adapted to receive optically readable digital data on at least one readable surface, the at least one readable surface arranged in about a plane and a data disk adapted to receive optically readable digital data on at least one readable surface, the at least one readable surface arranged in about a plane. The apparatus also includes at least one cavity in the data disk. The at least one cavity is adapted to receive the data storage insert in a unique orientation, wherein the plane of the optically readable digital data on the data storage insert is in about the same plane as the plane of the optically readable digital data on the data disk. Also, the data on the data disk and the data on the data storage insert are configured to be read by an optical data disk reader.

Another aspect of the present invention is an apparatus including a data storage insert configured to receive optically readable digital data on at least one readable surface and a host data disk configured to receive optically readable digital data on at least one readable surface. The apparatus further includes at least one aperture, in the host data disk, that is configured to accept the data storage insert.

Another aspect of the present invention is a method including placing optically readable digital data in one or more tracks on a host data disk; forming at least one cavity in the host data disk; and configuring the at least one cavity to accept a data storage insert. The method further includes placing optically readable digital data on the data storage insert, securing the data storage insert in the cavity; and aligning the optically readable digital data on the data storage insert, with the data on the host data disk.

Another aspect of the present invention is a method including forming at least one aperture in a host data disk adapted to accept digital data and configuring the at least one aperture to accept a data storage insert. The data storage insert is adapted to accept digital data. The method further includes securing the data storage insert in the at least one aperture and placing host data disk with data storage insert in an optical disk drive.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the present invention may admit to other equally effective embodiments.

FIG. 1a is a perspective view of one embodiment a host data disk and an insert in accordance with aspects of the invention.

FIG. 1b is a top plan view of the host data disk of FIG. 1a in accordance with aspects of the invention.

FIG. 2a and 2b is a fragmented cross section view along line a-a′ of the host data disk and the insert of FIG. 1b in accordance with aspects of the invention.

FIG. 3a is a perspective view of one embodiment of a host data disk and an insert in accordance with aspects of the invention.

FIG. 3b is a top plan view of the host data disk of FIG. 3a in accordance with aspects of the invention.

FIG. 3c is a cross section view along line b-b′ of the host data disk and the insert of FIG. 3b in accordance with aspects of the invention.

FIG. 3d is a cross section view along line b-b′ of the host data disk and the insert of FIG. 3b in accordance with aspects of the invent

FIG. 4a is a perspective view of one embodiment of a host data disk and an insert in accordance with aspects of the invention.

FIG. 4b is a top plan view of the host data disk of FIG. 4a in accordance with aspects of the invention.

FIG. 4c is a cross section view along line c-c′ of the host data disk and the insert of FIG. 4b in accordance with aspects of the invention.

FIG. 4d is a cross section view along line c-c′ of the host data disk and the insert of FIG. 4b in accordance with aspects of the invention.

FIG. 5 is a top plan view of the host data disk and a data insert in accordance with aspects of the invention.

FIG. 6 is a top plan view of the host data disk and a data insert in accordance with aspects of the invention.

### DETAILED DESCRIPTION OF THE PREFERRED EMBODIMENT

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

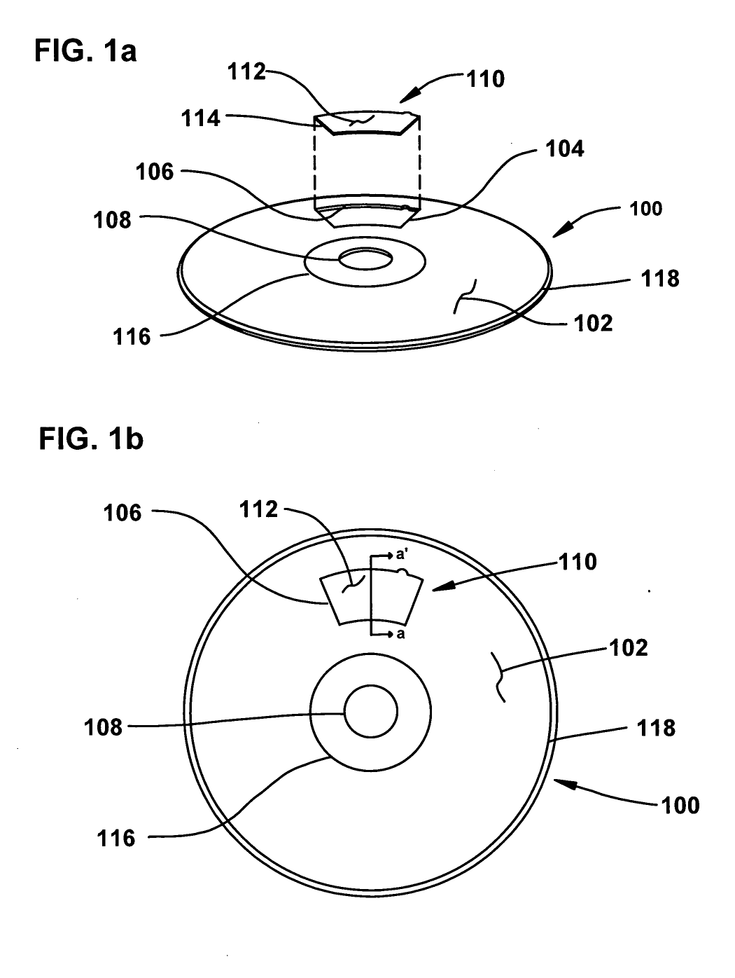

FIG. 1a is a perspective view of one embodiment a host data disk 100 and a data insert 110 in accordance with aspects of the invention. FIG. 1b is a top plan view of one embodiment a host data disk 100 and a data insert 110 in accordance with aspects of the invention. Host data disk 100 includes a central aperture 108 for engaging the spindles of optical disk readers, for example CD or DVD readers and drives. Host data disk 100 also includes a host information area 102 defined by an inner limit boundary 116 and an outer limit boundary 118. An information area may be an area in which digital data may be placed in the form of pits, burns, or other optically readable form, capable of detection by CD or DVD drives. A data aperture 104 may be located within host information area 102. Data aperture 104 is defined by an aperture sidewall 106. Data aperture 104 is adapted to receive the data insert 110. Data insert 110 includes an insert information area 112 and an insert sidewall 114. Data insert 110 is about the same thickness as host disk 100 and about the same shape as data aperture 104. Data aperture 104 and data insert 110 are illustrated as being formed in complimentary, non-symmetrical shapes. Such non-symmetrical shapes may be used to advantage to constrain data insert 110 in a unique orientation with respect to host data disk 100. The nonsymmetrical shape illustrated in FIGS. 1a, 1b are for illustrative purpose and many nonsymmetrical shapes may be employed to advantage.

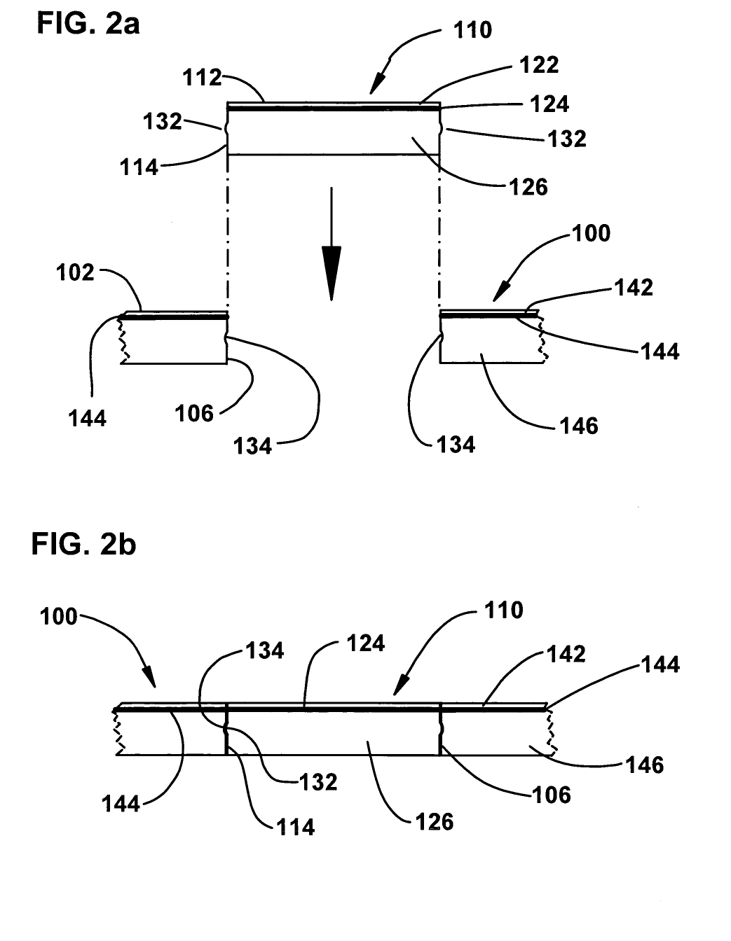

FIG. 2a and 2b are fragmented cross section views along line a-a′ of FIG. 1b of the host data disk 100 and the data insert 110, in accordance with aspects of the invention. FIG. 2a shows data insert 110 aligned for insertion into host disk 100. FIG. 2b illustrates the data insert 110 inserted and engaged in data aperture 104 host disk 100. Host data disk 100 may include a host polycarbonate substrate layer 146, a host data layer 144, and a host protective coating layer 142. Digital data may be placed in host data layer 144, in the form of pits, burns, or other optically active forms capable of interfering with the reflectivity within the host data layer 144. Host data layer 144 may include one or more layers of digital data. Such digital data within host data layer 144 may be adapted to be capable of detection by CD or DVD readers and drives. Data insert 110 may include an insert polycarbonate substrate layer 126, an insert data layer 124, and an insert protective coating layer 122. Digital data may be placed in data layer 124, in the form of pits, burns, or other optically active forms, capable of interfering with reflectivity within insert data layer 124. Insert data layer 124 may include one or more layers of digital data. Such digital data within host data layer 124 may be adapted to be capable of detection by CD or DVD readers and drives.

The host disk aperture side wall 106 may include a curved mating surface 134 for constraining data insert 110 in a position for advantage. Data insert 110 may be bounded by sidewall 114. Sidewall 114 may include a curved mating surface 132 for engaging mating surface 134. Curved mating surface 134 and curved mating surface 132 are illustrated as forming a detent structure. However, many simple or complex, complimentary surfaces may serve to constrain the data insert 110 relative host data disk 100 and may be used to advantage.

FIG. 2b illustrates data insert 110 in an engagement position with host data disk 100. In the illustrated engagement position, insert data layer 124 is illustrated in an orientation that places the plane of the insert data layer 124 about coplanar with host data layer 144. The insert data layer 124 may be constrained in such planer orientation relative the host data layer 144 by the engagement of curved mating surface 132 with curved mating surface 134. Mating surface 132 and mating surface 134 are illustrated as convex and concave respectively, by way of example only. It may be appreciated by practitioners in the art, that mating surface 132 may be concave and mating surface 134 may be convex. It may further be appreciated by practitioners in the art that an interference fit between curved mating surfaces 132, 134 may be used to advantage. Data insert 110 is illustrated as being inserted into host data, disk distal the host polycarbonate substrate layer 146. However, curved mating surfaces 132,134 may also be configured to accept insertion of the data insert 110 from the side of the host data disk 100 proximate the host polycarbonate substrate layer 146. It may further be appreciated by practitioners of the art that sidewall 106 and sidewall 114 may be configured to form an interference fit for a portion of their respective surfaces to secure data insert 110 relative host disk 100.

In one example of operation, host data disk 100 and data insert 110 may contain digital data readable by a CD or DVD disk reader. Data insert 110 may be conveyed separately in small packages containing consumer products, such as cosmetics, medications, toys, parts, and the like. In one example of use, data insert 110 may be removed from the package of medication and inserted into a host data disk 100 that has been adapted to receive such data insert 110. Mating surfaces 132 and 134 retain the data insert 110 in position relative the host data disk 100 during rotation. The complimentary, asymmetrical shapes of data aperture 104 and the data insert 110 constrain the data insert 110 in a unique orientation relative the host data disk 100 and thereby prevent the user from inserting the data insert 110 backwards or upside down into the host data disk 100. The host data disk 100 and data insert combination may be read in a disk reader or drive with associated computing power and screen display. The associated computing power may display the important product or medical information to the consumer.

In one example of operation host data disk 100 may contain encrypted or encoded data or software. Data insert 110 may contain an encryption key or decoding information for enabling the optical disk reader to decrypt the data or software acquired from the host data disk 100.

In one example of operation, data insert 110 may contain encrypted or encoded data or software. Host data disk 100 may contain an encryption key or decoding information for enabling the optical disk reader to acquire the data or software from the data insert 110.

In one example of operation, the complimentary, shapes of data aperture 104 and data insert 110 may be configured to function as a unique physical lock and key. Thus host disk 100 may be prevented from being read without a unique, complimentary data insert 110, Similarly, the data insert 110 may be prevented from being read without a unique, complimentary host disk 100. A host disk with two or more inserts would produce an additional level of security similar to a door having two or more locks and requiring two or more keys to enter.

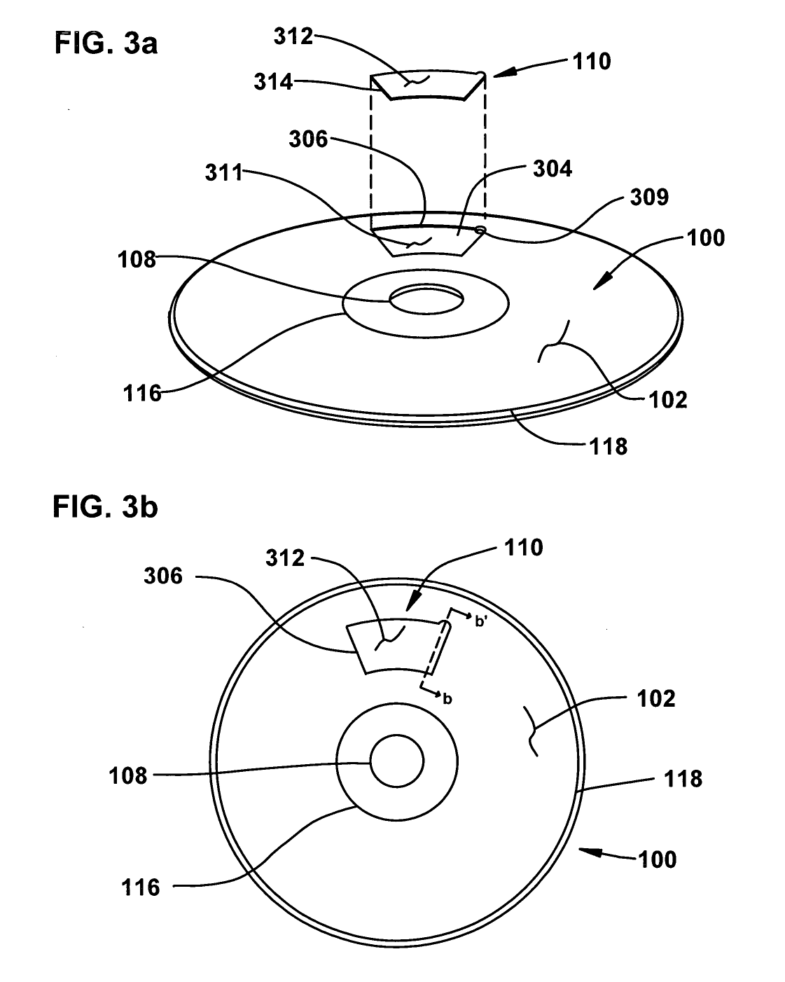

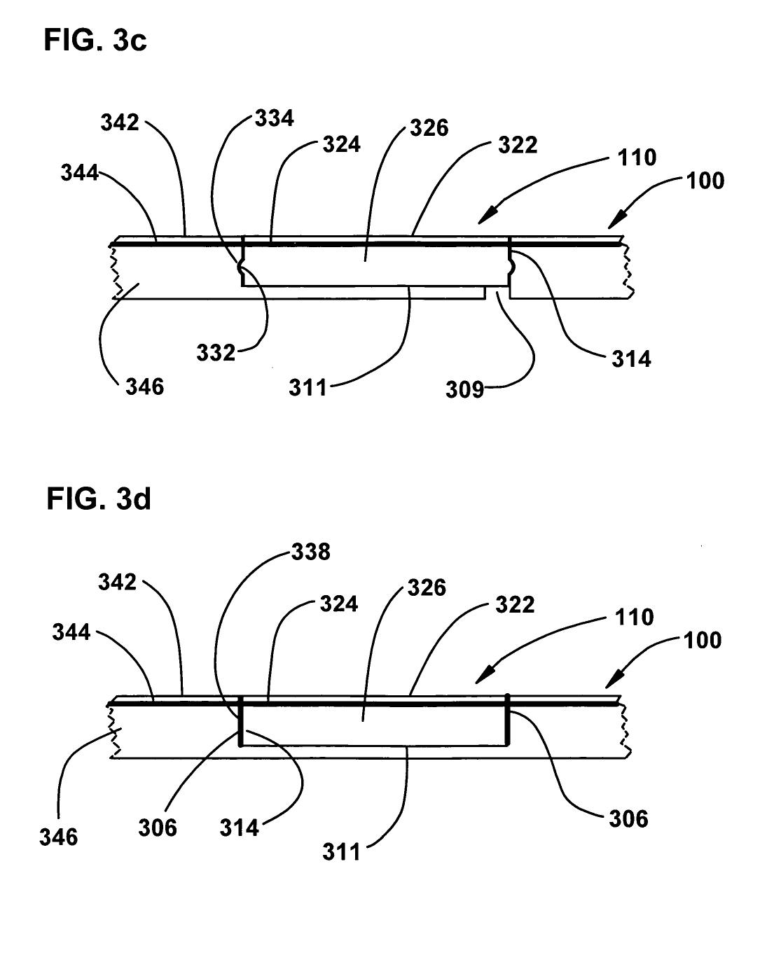

FIG. 3a is a perspective view of one embodiment of a host data disk 100 and a data insert 110 in accordance with aspects of the invention. FIG. 3b is a top plan view of the host data disk 100 and data insert 110 in accordance with aspects of the invention. Host data disk 100 includes a central aperture 108 for engaging the spindles of CD or DVD drives. Host data disk 100 also includes a host information area 102 defined by an inner limit boundary 116 and an outer limit boundary 118. A shaped docking cavity 304 may be located in host information area 102. The cavity 304 is defined by a cavity sidewall 306 and a continuous bottom surface 311. A cavity may be a hole or aperture, with or without a bottom. Cavity 304 is illustrated as having a bottom, including the continuous surface 311. Bottom surface 311 may include an aperture 309. Aperture 309 may be used to expedite removal of data insert 110 when desired by allowing pressure to be exerted on the back of data insert 110. The cavity 304 is adapted to receive data insert 110. Data insert 110 includes an insert information area 312 and an insert sidewall 314. Data insert 110 is about the same thickness as the depth of shaped docking cavity 304 and about the same shape as host disk shaped docking cavity 304. Shaped docking cavity 304 and data insert 110 are illustrated as being formed in a non-symmetrical shape. Such non-symmetrical shapes may be used to advantage to constrain data insert 110 in a unique orientation relative host data disk 100. The nonsymmetrical shape illustrated in FIGS. 3a, 3b are for illustrative purpose and many nonsymmetrical shapes may be employed to advantage.

FIG. 3c is a fragmented cross section view along line b-b′ of the host data disk 100 and the data insert 110 of FIG. 3b in accordance with aspects of the invention. Host data disk 100 includes a polycarbonate substrate layer 346, a host data layer 344 and a protective coating layer 342. Digital data may be placed in host data layer 344, in the form of pits, burns, or other optically active forms capable of interfering with the reflectivity within host data layer 344. Host data layer 144 may include one or more layers of digital data. Such digital data within host data layer 344 may be configured to be capable of detection by CD or DVD readers and drives. Data insert 110 includes an insert polycarbonate substrate layer 326, an insert data layer 324, and an insert protective layer 322. Digital data may be placed in insert data layer 324 in the form of pits, burns, or other optically active forms, capable of interfering with the reflectivity within insert data layer 324. Insert data layer 324 may include one or more layers of digital data. Such digital data within insert data layer 324 may be configured to be capable of detection by CD or DVD readers or drives.

Continuous surface 311 may be adapted to constrain data insert 110 in an orientation that places insert data layer 324 about coplanar with host data layer 344. Insert sidewall 314 may engage host disk cavity sidewall 306 to constrain data insert 110 laterally, for advantage. FIG. 3c illustrates a curved mating surface 332 and a curved mating surface 334. Curved mating surfaces 332 and 334 are illustrated as convex and concave respectively, by way of example only. It may be appreciated by practitioners in the art, that mating surface 332 may be concave and mating surface 334 may be convex. Other simple or complex complimentary curves may be adapted to constrain the data insert 110 relative the host disk 100 to advantage. It may be appreciated by practitioners of the art that sidewall 306 and sidewall 314 may be configured to form an interference fit for a portion of their respective surfaces to secure data insert 110 relative host disk 100. Aperture 309, in the continuous surface 311, may facilitate removal of the data insert 110, when desired.

FIG. 3d is a cross section view along line b-b′ of the host data disk 100 and the data insert 110 of FIG. 3b in accordance with aspects of the invention. An adhesive 338 may be placed between insert sidewall 314 and cavity sidewall 306 to constrain data insert 110 within shaped docking cavity 304. Adhesive 338 may also be placed on continuous surface 311 to secure data insert 110 within shaped docking cavity 304. Sidewall 306 and sidewall 314 may be configured to form an interference fit for a portion of their respective surfaces to secure data insert 110 relative host disk 100. Such adhesive may be selected from a group of adhesives that renders the data insert 110 removable to advantage. Such adhesive may also be selected from a group of adhesives that renders the data insert 110 permanently affixed to advantage. In such case where it is desirable to permanently affix the data insert 110 to the host data disk 100, no aperture, such as the aperture 309 in FIG. 3c, is necessary in the bottom surface 311, as is illustrated in FIG. 3d.

In operation, host data disk 100 and data insert 110 may be imprinted with digital data, readable by a CD or DVD disk reader. Data insert 110 may be conveyed separately in small packages containing consumer products, such as cosmetics, medications, small toys, small parts, and the like. Data insert 110 may then be inserted into host data disk 100 and placed in an optical disk reader for retrieving the digital data imprinted on the data insert 110. An interference fit, a detent fit, fit created by complex curvature of curved mating surfaces 332 and 334, or an adhesive may serve to retain the data insert 110 in position relative host data disk 100 during rotation within the reader.

In one example of use, data insert 110 may be removed from a package of cosmetics, inserted into an appropriate host disk 100, and placed in an optical disk reader with associated computing system. The optical disk reader and the associated computing system in turn may read the digital information on host disk 100 and data insert 110 and display the data in the form of a demonstration of the proper use of the cosmetic, or product information, or a list of possible allergic contents.

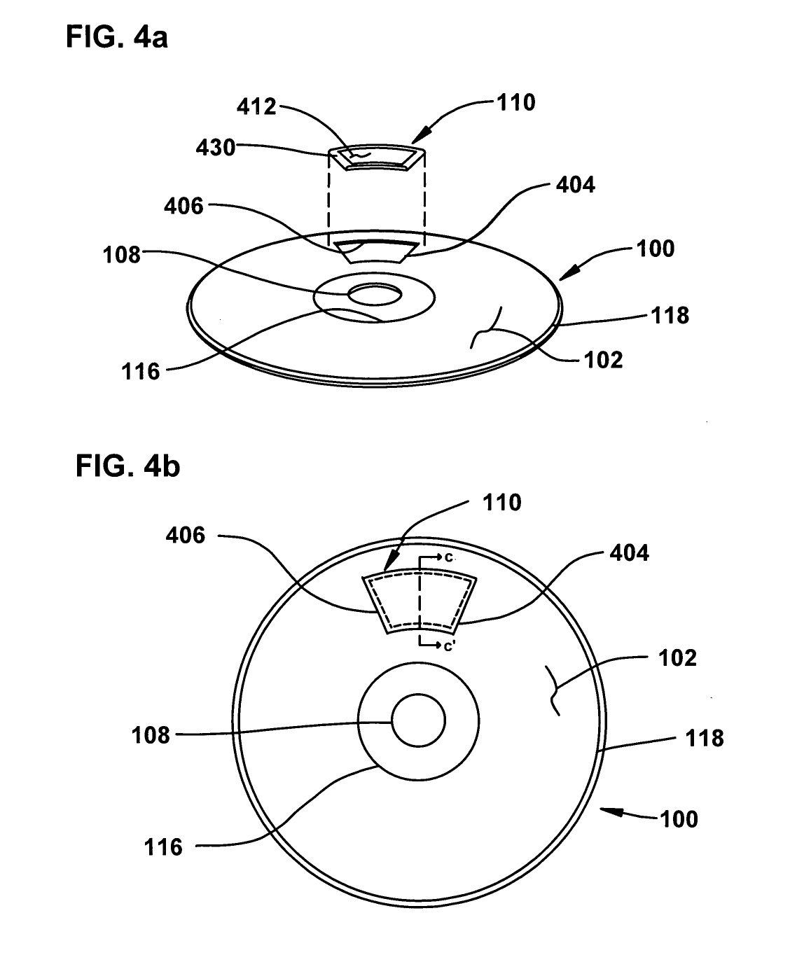

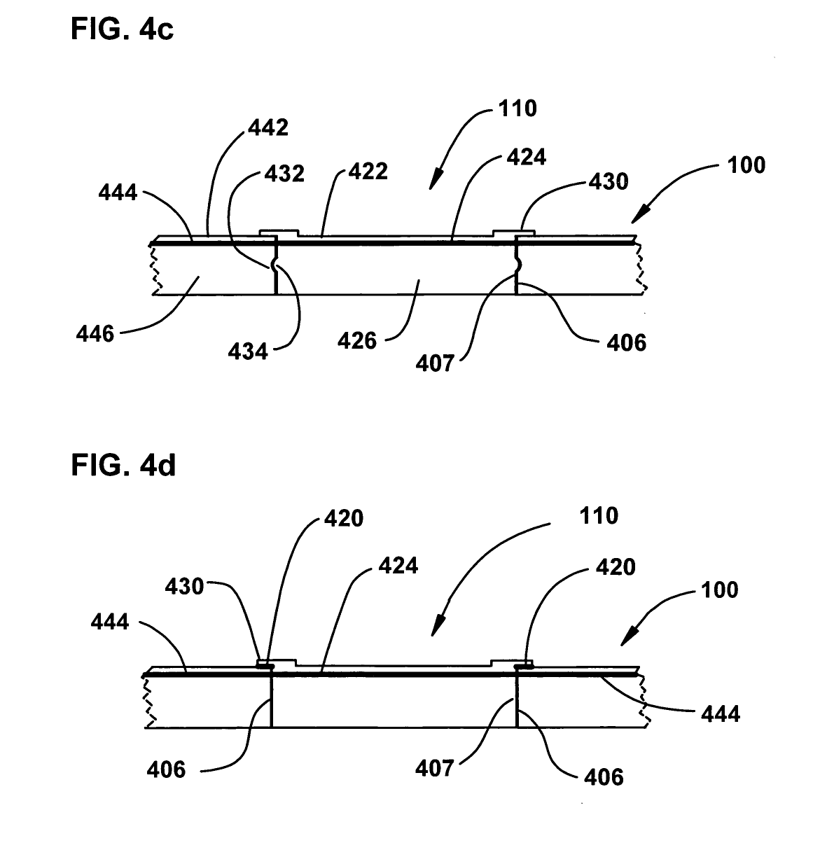

FIG. 4a is a perspective view of a host data disk 100 and a data insert 110 in accordance with aspects of the invention. FIG. 4b is a top plan view of the host data disk 100 and data insert 110, in accordance with aspects of the invention. Host data disk 100 includes a central aperture 108 for engaging the spindles of CD or DVD drives. Host data disk 100 also includes a host information area 102 defined by an inner boundary 116 and an outer boundary 118. A shaped aperture 404 may be located in host information area 102. The shaped aperture 404 is defined by a sidewall 406. The shaped aperture 404 is adapted to receive the data insert 110. Data insert 110 includes an insert information area 412 and an extended edge 430. Shaped aperture 404 and data insert 110 are illustrated as being formed in a non-symmetrical shape. Such non-symmetrical shapes may be used to advantage to constrain data insert 110 in a unique orientation relative host data disk 100. The nonsymmetrical shape illustrated in FIGS. 4a, 4b are for illustrative purpose and many nonsymmetrical shapes may be employed to advantage.

FIG. 4c is a fragmented cross sectional view along line c-c′ of one embodiment of the host data disk 100 and the data insert 110 of FIG. 4b in accordance with aspects of the invention. Data insert 110 is bounded by an insert sidewall 407. The data insert 110 may be constrained laterally relative the host data disk 100 by the engagement of sidewall 407 with sidewall 406. Data insert includes an insert data layer 424 as described above in insert data layer 124. Host data disk 100 includes a host data layer 444 as described above for host data layer 144. Insert data layer 424 is illustrated in an orientation that places the plane of the insert data layer 424 about coplanar with the host data layer 444. Such coplanar alignment of 424 relative layer 444 may be facilitated by engagement of the lower surface of the extended edge 430 with a portion of the upper surface, of the host disk 100, proximate shaped aperture 444. Data insert 110 my be further constrained within host shaped aperture 404 by engagement of a curved mating surface 432 with a curved mating surface 434. Mating surfaces 432 and 434 are shown as a concave and convex detent structure for illustrative purposes only. It may be appreciated by practitioners in the art that many complex or simple curves may be applied to curved mating surfaces 432, 434 for the purpose of constrain data insert 110 relative host disk data 100.

FIG. 4d is a fragmented cross sectional view along line c-c′ of one embodiment of the host data disk 100 and the data insert 110 of FIG. 4b in accordance with aspects of the invention. In the embodiment illustrated in FIG. 4d, sidewall 406 and sidewall 407 are illustrated about perpendicular to the plane of the host data disk 100, and are absent curved surfaces 432, 434. Data insert 110 may be constrained within host shaped aperture 444 by a layer of an adhesive 420 placed between the bottom of the extended edge 430 and the upper surface of the host disk 100 proximate shaped aperture 404. Adhesive 420 may bond the data insert 110 within the shaped aperture 404. Adhesive 420 may be selected to make such bond permanent or nonpermanent.

The present invention contemplates a variety of embodiments of the optical host disk and compatible insert. For instance, the data layer of the optical host disk 100 may have one or more reflective layers. The data layer operational structures may include pits, lands, grooves, wobble grooves, dye marks, chevron marks, or any combination thereof. The data layer operational structures may act as phase components or create interference patterns that provide tracking and synchronization information to the optical disk drive. Different surfaces in the optical disk assembly may be metalized or coated with materials with a variety of reflective properties. Such coatings may be reflective, semi-reflective, transmissive, semi-transmissive, or anti-reflective. The materials used in the various layers may be dielectric or non-dielectric. The data layer operational structures may be in a CD format (including a CD-R and CD-RW format), a DVD format (including a DVD-R format, a DVD-RW format, and a DVD-RAM format), or any combination thereof. The data layer operational structures may be physically imprinted in a surface of the data layer, or encoded in a hologram. A custom format for data layer operational structures may also be used, for example where the disk assembly may be read by a custom decoding device. In the interests of clarity and simplicity, FIGS. 1a, 1b, 3a, 3b, 4a, and 4b illustrate use of a single data insert 110. However, multiple data inserts may be used with a single host data disk.

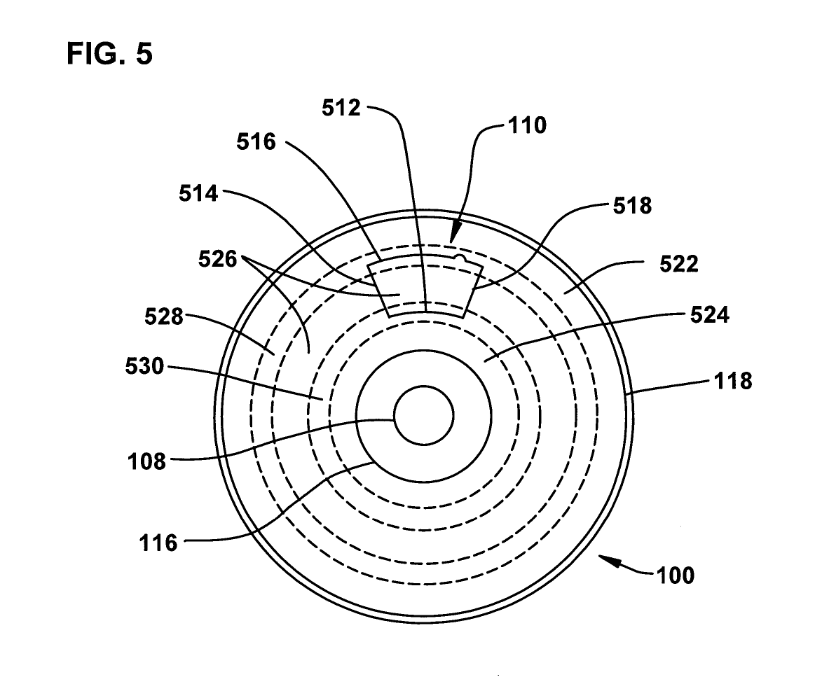

FIG. 5 is a top plan view of one embodiment of the data disk 100 of FIG. 1 in accordance with aspects of the invention. FIG. 5 illustrates disposition of the data insert 110 in a “zoned constant linear velocity” (ZCLV) formatted layout. The operational structures in the optical disk assembly may be configured and organized in accordance with the ZCLV. The ZCLV format is detailed in various industry standards, including the DVD-RAM specification. The ZLCV format may be disposed in the host information area 102 of data disk 100 relative data insert 110. In one embodiment, a perimeter of data insert 110 may include an inner tangential engagement region 512, a leading edge engagement region 514, an outer tangential engagement region 516 and a trailing edge engagement region 518. Engagement regions 512, 514, 516, 518 are defined by the engagement of aperture sidewall 106 with data insert sidewall 114.

The ZCLV may be divided into multiple zones (not shown) from the inner limit boundary 116 to the outer limit boundary 118 of the host information area 102. For example, one DVD-RAM ZCLV format allows up to 24 zones. One or more adjacent zones may be collected into defined use areas. Beginning from the inner limit boundary 116 and proceeding radially in the direction of the outer limit boundary 118, a host disk inner data area 524, is initially encountered. The host disk inner data area 524 may include one or more zones. Such zones are typically dedicated to normal disk drive and information processing management. Such zones may include additional software and data dedicated to management of data in the insert data layer 124 and host data layer 144, of data insert 110 and host disk 100 respectively, to advantage. The host information area 102 further includes a host disk inner bypass area 530. Host inner bypass area 530 may include one or more zones. Host inner bypass area 530 is radially distal the host disk inner data area 524 from the central aperture 108. The host disk inner bypass area 530 includes the inner tangential engagement region 512 of the data insert 110. Typically, such bypass area 530 may include no usable data. Such bypass area 530 enables the disk reader to avoid tracking problems by skipping over the tangential region 512.

The host information area 102 further includes an insert data area 526 radially distal inner bypass area 530. Insert data area 526 may include one or more zones. The insert data area 526 may include data on the host disk 100 and data in the data insert 110. The host information area 102 further includes a host disk outer bypass area 528. Outer limit boundary 118 may optionally be disposed within outer bypass area 528. The host disk outer bypass area 528 includes the outer tangential engagement region 516 of the data insert 110. Typically, such bypass area 528 may include no usable data. Such bypass area 528 enables the disk reader to avoid tracking problems by skipping over the outer tangential region 516. The host information area 102 further may include a host disk outer data area 522, radially distal the insert data area 526. Host outer data area 522 may include one or more zones. The outer data area 522 may be dedicated to data or software deemed useful. Host outer data area 522 may also be omitted as for example when outer limit boundary 118 falls within outer bypass area 528.

In operation, the host disk 100 with data insert 110 would be placed in a disc drive associated with a computing processor. The disk drive would then access the host disks inner data area 524 for information regarding ZLCV format and protocol, management of the data found on host disk or data insert or both, and for information regarding the insert location and protocol for reading of writing to the insert. The disk drive would then check for the presence of the appropriate insert in the insert data area 526. If the appropriate insert were present then the disk drive would read the insert 110 and the associated computing processor would process the insert data. If desired, the processed insert data could then be displayed.

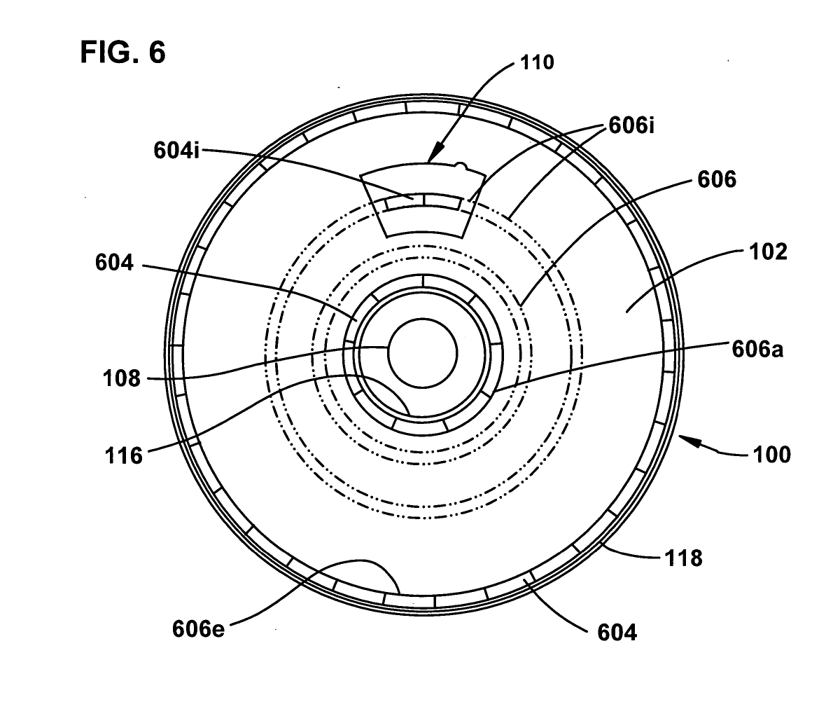

FIG. 6 is a top plan view of one embodiment of the host data disk 100 and data insert 110 in accordance with aspects of the invention. FIG. 6 schematically illustrates host disk 100 with central aperture 108 and data insert 110. The information area 102 is defined by inner limit 116 and outer limit boundary 118. In this simplified example, the information area 102 may be divided into a plurality of concentric zones 606 similar to DVD-RAM ZCLV format. Also similar to DVD-RAM ZCLV format, such zones 606 may be divided into one or more sectors 604. Simple geometry dictates that an inner zone 606a proximate to inner limit 116 will have fewer sectors 604 than an outer zone 606e proximate to outer limit 118, when sectors 604 are of about equal length. In other words, a tangential length of zones 606 proximate the central aperture 108 will be shorter than the tangential length of zones 606 more distal the central aperture 108. For example, the inner zone 606a is illustrated including 9 sectors 604 whereas the outer zone 606e is illustrated as containing 30 sectors 604. An optical disk drive may be configured to scan each zone 606 at a constant rate. The optical disk reader accomplishes constant rate scanning by rotating the host disk at a higher angular velocity when it scans the zones proximate inner limit 116, such as the inner zone 606a for example, than when it scans the zones 606 near outer limit 118, such as the outer zone 606e for example. Such controllable angular velocity enables the optical disk reader to maintain a substantially constant scanning rate of the sectors 604, or tangential velocity, for all the zones 606 on the ZCLV like host disk 100. Moreover, an optical disk reader may be configured to adjust the angular velocity to achieve a slower or faster tangential scanning rate of the sectors 604 in a predetermined zone 606, to advantage.

FIG. 6 also illustrates a zone 606i containing a plurality of sectors 604. Zone 606i includes a zone host segment 606i′ contained in the host disk 100 and an insert zone segment 606i″ contained in the data insert 110. One or more of the sectors 604 lie within the insert zone segment 606i″. The host zone segment 606i′ and the insert zone segment 606i″ are disposed in close alignment. For clarity, only a few zones 606, namely zone 606a, 606e, and 606i are illustrated. Many more zones 606 may be present. It may be appreciated by practitioners in the art that depending on data insert 110 size, shape, and location, the data insert 110 could include one or more active ZCLV zones 606 having segments of the zone 606 falling within the data insert 110. Each of the zone segments falling within the data insert 110 may have one or more sectors 604.

In one example of operation, the host disk 100 with data insert 110 would be placed in a disc drive associated with a computing processor. The disk drive would then access the host disks inner data sectors 606a and adjacent sectors for information regarding ZLCV format and protocol, management of the data found on host disk or data insert or both, and for information regarding the insert location and protocol for reading or writing to the insert. The disk drive would then check for the presence of the appropriate insert in the insert data sectors 606i. If the appropriate insert sectors were present then the disk drive would read the insert sectors 604i and the associated computing processor would process the insert data. If desired, the processed insert data could then be displayed.

Numerous other operational formats are defined by the industry, which could be adapted to access data on the host disk 100 in conjunction with data on the data insert 110. For example, the Standard ECMA—130, 2nd Edition—June 1996 is well known in the art, and is hereby incorporated by reference in its entirety. Moreover, it may be appreciated by practitioners in the art that various operational formats may be devised to use the data insert 110 and host disk 100 to advantage, without departing from the invention. For example, operational protocols could exploit an interaction of host and insert information to enhance security of information on both the host disc and one or more data inserts. For example, a host disc could contain enciphered data which could not be read with the matching data insert that contained the encryption key for the host disc encrypted data.

While the foregoing is directed to embodiments of the present invention, other and further embodiments of the invention may be devised without departing from the basic scope thereof, and the scope thereof is determined by the claims that follow.

1. An apparatus comprising:
a data storage insert adapted to receive optically readable digital data on at least one readable surface, the at least one readable surface arranged in about a plane;
a data disk adapted to receive optically readable digital data on at least one readable surface, the at least one readable surface arranged in about a plane; and
at least one cavity in the data disk, the at least one cavity adapted to receive the data storage insert in a unique orientation, wherein the plane of the optically readable digital data on the data storage insert is in about the same plane as the plane of the optically readable digital data on the data disk, wherein the data on the data disk and the data on the data storage insert are configured to be read by an optical data disk reader.

2. The apparatus of claim 1, wherein:
the at least one cavity includes a side wall having a mating surface and the data storage insert includes a side wall having a complimentary mating surface, wherein the mating surface and the complimentary mating surface cooperate to secure the data storage insert in a predetermined position relative the data disk.

3. The apparatus of claim 1, wherein:
at least one of the cavities includes a surface distal the at least one readable surface of the data disk, the continuous surface adapted to constrain the data storage insert in a predetermined position relative the data disk.

4. The apparatus of claim 1, wherein:
the cavity is non symmetrical.

5. The apparatus of claim 4, wherein:
the data storage insert shape is complimentary to the non symmetrical cavity, wherein the cavity receives the data storage insert in a unique orientation.

6. The apparatus of claim 1, wherein:
the data disk includes at least one track storing digital data, the digital data including program information for accessing the data storage insert.

7. The apparatus of claim 1, wherein:
the data disk includes at least one track storing digital data, the digital data including location information for the data storage insert received by at least one of the cavities.

8. The apparatus of claim 1, wherein:
the data disk includes digital information for accessing the data on the data storage insert.

9. The apparatus of claim 1, wherein:
the data disk includes digital information for processing the data on the data storage insert.

10. The apparatus of claim 1, wherein:
the data insert is secured in the host data disk by an adhesive.

11. The apparatus of claim 1, wherein:
data on the data disk is encrypted and the data storage insert includes encryption key information enabling decryption of the encrypted data on the data disk.

12. The apparatus of claim 1, wherein:
data on the data storage insert is encrypted and the data disk includes encryption key information enabling decryption of the encrypted data on the data storage insert.

13. An apparatus comprising:
a data storage insert configured to receive optically readable digital data on at least one readable surface;
a host data disk configured to receive optically readable digital data on at least one readable surface; and
at least one aperture in the host data disk, wherein the at least one aperture is configured to accept the data storage insert.

14. The apparatus of claim 13, wherein:
the data storage insert includes a side wall having a mating surface and the at least one aperture has a complimentary mating surface in a side wall, wherein the mating surface and the complimentary mating surface cooperate to secure the at least one readable surface of the data storage insert about planer relative the at least one readable surface of the host data disk.

15. The apparatus of claim 13, wherein:
the data insert is secured in the host data disk by an adhesive.

16. The apparatus of claim 13, wherein:
the aperture is non symmetrical.

17. The apparatus of claim 16, wherein:
the data storage insert shape is complimentary to the non symmetrical aperture, wherein the aperture receives the data storage insert in a unique orientation.

18. The apparatus of claim 13, wherein:
the host data disk includes digital information for accessing the data on the data storage insert.

19. The apparatus of claim 13, wherein:
the host data disk includes digital information for processing the data on the data storage insert.

20. The apparatus of claim 13, wherein:
data on the host data disk is encrypted and the data storage insert includes encryption key information enabling decryption of the encrypted data on the host data disk.

21. The apparatus of claim 13, wherein:
data on the data storage insert is encrypted and the host data disk includes encryption key information enabling decryption of the encrypted data on the data storage insert.

22. The apparatus of claim 13, wherein:
the data storage insert includes at least one track containing data describing the number of data bits in the track.

23. The apparatus of claim 13, wherein:
the data storage insert includes at least one bypass region proximate a tangential engagement region.

24. The apparatus of claim 13, wherein:
the host data disk includes at least one bypass region proximate a tangential engagement region.

25. An optical disc, comprising:
optically readable digital structures which have encoded tracking information, and data location information enabling an optical disc reader to find a location disc that is determinable from the location information; and
an insert section capable of receiving an insert having optically readable digital structures which can be read by the optical disc reader.
